(19) United States
(12) Patent Application Publication
(10) Pub. No.: US 2010/0011569 A1
(43) Pub. Date: Jan. 21, 2010

(54) APPARATUS AND METHOD FOR ASSEMBLING SEVERAL SEMICONDUCTOR DEVICES ONTO A TARGET SUBSTRATE

(75) Inventors: Claus DIETRICH, Thiendorf OT Sacka (DE); Joerg Kiesewetter, Thiendorf OT Sacka (DE)

Correspondence Address: HESLIN ROTHENBERG FARLEY & MESITI PC, 5 COLUMBIA CIRCLE, ALBANY, NY, 12203, US

(73) Assignee: SUSS MicroTec Test Systems GmbH, Sacka (DE)

(21) Appl. No.: 12/199,401

(22) Filed: Aug. 27, 2008

(30) Foreign Application Priority Data
Jul. 18, 2008 (DE) 10 2008 033 903.2

(51) Int. Cl. B23P 19/04

(52) U.S. Cl. 29/740

(57) ABSTRACT

A method and apparatus are provided for assembly of several semiconductor components on a target substrate. At least two semiconductor components are removed from a dispenser by a transfer device and simultaneously mounted in predefined target positions on the target substrate. The apparatus includes positioning units for positioning of the semiconductor components relative to the target substrate. Feed of the target substrate occurs by a first positioning unit into an assembly area where the semiconductor components are mounted on the target substrate in a first X direction, and feed of the transfer device with the semiconductor components occurs by a second positioning unit into the assembly area in a second Y direction. Both directions deviate from each other and the assembly area represents vicinity of the intersection point of the X and Y directions. Removal of the process target substrate from the assembly area continues its feed movement.

### BACKGROUND

The invention concerns a method for assembling several semiconductor components onto a target substrate, in which at least two semiconductor components are simultaneously removed from the dispenser by means of a transfer device and mounted in predefined target positions on the target substrate. The invention also concerns an apparatus for assembly of the semiconductor components.

Such an apparatus regularly includes positioning units to position the semiconductor components relative to the target substrate and a transfer device for simultaneous removal of at least two semiconductor components from a dispenser and their simultaneous assembly on the target substrate in predefined target positions and with a spacing relative to each other.

Such assembly of several semiconductor components onto a target substrate is used, among other things, to produce concentrator photovoltaic arrangements (CPV) in which, in order to increase light yield, the individual photovoltaic cells are arranged as semiconductor components on a support substrate, for example, glass in an array at a spacing relative to each other. Each photovoltaic cell is assigned an optical element, which is arranged at a spacing above the cell in order to concentrate the light of an incident surface much larger in comparison with the photovoltaic cell on a surface of the cell of, say, less than 1 mm². A significant efficiency factor is the precise positioning and assembly of the individual photovoltaic cells on the support substrate, which is referred to as target substrate in conjunction with assembly of the cells. Precise positioning and assembly of the semiconductor components onto a target substrate with high throughput is also essential for integration technologies of micro- or nanoelectronic systems with two or three-dimensional layout.

The required precision with simultaneously high throughput is offered, for example, by the so-called transfer printing process in which semiconductor components are grasped with a punch, aligned relative to the target substrate by means of the punch and printed onto the target substrate. Because of the orders of magnitude to be processed here, especially high requirements are imposed on the precision of alignment of the semiconductor component, punch and target substrate relative to each other.

### BRIEF SUMMARY OF THE INVENTION

A method and apparatus are provided which can be integrated in an inline system for processing of a large number of structures to produce photovoltaic or microelectronic or other comparable systems.

The described method defines two fundamental movement directions deviating from each other that serve to feed the components to be mounted with each other into that area of the system in which assembly of the semiconductor components onto a target substrate occurs, here referred to as the assembly area. The movement that initially serves to feed the target substrate is then continued after the finishing of assembly of semiconductor components with retention of the direction. The alignment between the target substrate and the semiconductor components therefore occurs by establishing its position, subsequently referred to as assembly position, along its path and also by feeding the semiconductor components to this assembly position, which occurs from an initial position apart from the path of the target substrate. Achievement of this assembly position is simple for both movement directions and possible with sufficient accuracy by known methods, for example, by determining the distance covered from the initial point, if the position is known with reference to this initial point, or by the arrival of a reference mark, which is positioned with reference to the position being approached. In contrast to the term assembly area, the relative position between the target substrate and the semiconductor components and therefore position of the transfer device carrying the semiconductor components is to be referred to as the assembly position, in which no further movement in one of the two movement directions is necessary for assembly of the semiconductor components onto the target substrate. The assembly position must therefore be set with the required precision.

Both movement directions are steps to be executed separately from each other and at the same time, for example, for adjustment or alignment of both components with respect to this position of the target substrate. The position is reached by each of the target substrates with constant accuracy so that during assembly of the semiconductor component onto a target substrate preparatory alignments of the semiconductor components are possible, which are to be mounted on a subsequent target substrate. In this way significantly shorter cycle times can be achieved, which are essentially dictated by the duration for assembly of the semiconductor components onto the target substrate.

Since several semiconductor components are simultaneously positioned with one feed movement, alignment of the target substrate and semiconductor components in principle requires alignment on a position in each plane relative to each other, which is defined by the two feed movements. Angular alignment and alignment in height are also simultaneously required.

By preparatory alignment of the target substrate and/or dispenser in angle and height it is also possible to reduce the actual feed movement to movement in only two directions, one for the target substrate and one for the semiconductor component, which is merely supplemented by a usual, final contacting movement that runs perpendicular to these two directions.

This concluding contacting movement will not be further taken up below, since the actual feed movement occurs until the components to be contacted are at a limited spacing relative to each other so that only a brief movement in one direction and without further adjustment is required to produce contact. The contacting movement can therefore be counted as part of mounting of the semiconductor components on the target substrate. At least one of the two positioning units described below therefore has, in addition to the movement direction with which the feed movement is executed, only one further possible movement direction with which a short movement with high precision can be accomplished and which lies perpendicular to the movement directions of the two positioning units. Referring to the term “assembly position, the term “contacting position” means that the assembly position is reached by the target substrate and the semiconductor components and only a short distance between the two components must be covered by such a contacting movement, which is directed perpendicular to the two feed movements. All subsequently described requirements on execution and precision consequently always refer only to feed movements that are required to reach the assembly position.

An assembly of both components, which includes at least fastening of the semiconductor components on the target substrate will be referred to here as an assembly of semiconductor components onto a target substrate. According to the previous and subsequent process for production of the complete component, electrical contacting can then also be included, if corresponding connection surfaces are prepared on both components. Fastening itself can occur with known methods, often by gluing. However, other methods are also possible, for example, by mechanical fixation or by temporary fastening that is finished by subsequent processes.

All process steps in inline systems, which are supposed to occur in one pass through the system, are arranged along a transport path of the product. In the described method this transport path is determined by the feed and further transport of the target substrate. Target substrates can therefore be continuously fed, each equipped with semiconductor components and then further transported. To minimize the demand for alignment of each target substrate and each set of semiconductor components to be assembled simultaneously, the target substrates of the dispenser can be aligned with reference to this preferred direction of the entire system even before their feed movement.

Alignment can also be divided here, as is often practiced, into coarse and fine alignment, in which, based on the repeatability of movements required for feed, a coarse alignment occurs in common for a large number of target substrates and dispensers. This is possible, for example, when they are stored in magazines in which the individual positions of each component are determined geometrically, generally by a vertical spacing. After coarse alignment of the magazine in the direction in which the feed movement occurs from this magazine, either the magazine itself is moved in order to produce the same initial position for each component or the feed movements of the components are supplemented by a defined and programmable travel path to achieve the uniform initial position. For the holding of semiconductor components in a magazine this means that the magazine itself can be arranged along a straight line which is defined by the Y direction. Such a magazine serves as a dispenser receptacle. As an alternative, a dispenser receptacle can also be arranged on this straight line on which a dispenser, which was for instance taken from a magazine arranged to the side of it, is positioned in order to use this dispenser receptacle as a geometrically defined starting point of each feed movement.

As an alternative, a coarse alignment can also occur through a handling system, which is used for example to transport individual components to the initial position of the always-repeating feed movements.

Based on decoupling of the feed movements of the target substrates and the semiconductor components, it is possible for one or both components to execute all required manipulations, preparations or position changes independently of each and simultaneously in terms of time and geometrically up to achievement of the assembly position so that a defined travel path is covered, to check the precise positioning and, if necessary, still make a correction before assembly of the semiconductor components of the target substrate occurs.

The feed described here also permits fully automatic assembly of the semiconductor components. For automated checking of the position of the target substrate and the semiconductor components relative to each other different aids are known, like adjustment marks, distance meters, step meters, image recognition systems or others. Supplementary processes can also be integrated in a programmable course of movement of one or both components, such as for example the aforementioned contacting movement, a cleaning step or defined accelerations, which can be required to receive or position the semiconductor components, depending on the configuration of a dispenser or the transfer device. Such movement processes are programmable for learning both by exclusively geometric relations and calculations and by a single process of the feed movements.

The two movement directions of the target substrate and semiconductor components are referred to here as X and Y direction merely to distinguish them. The fact that the two directions are at right angles to each other is no more essential than the position of the two directions being in a horizontal plane. If it is useful for manufacturing or positioning reasons, one of the directions can also run vertically, for example, as long as both directions deviate from each other.

If, however, in one variant of the process the X and Y directions are at right angles to each other, scanning of a number of assembly positions on a target substrate is possible with minimal adjustment expense. In this case one or more dispensers can be precisely aligned in height, angle and position with reference to a reference direction of the target substrate so that successive semiconductor components can then be taken from the dispenser and mounted on the target substrate until the target substrate is completely equipped. For this purpose the removal positions on one or more dispensers and the assembly positions on the target substrate are scanned. Likewise, with removal of semiconductor components from the dispenser an entire series of semiconductor components can also be simultaneously accepted and simultaneously mounted on the target substrate. In this case, to simplify the feed movements the alignments of the grid on the dispensers and the target substrate agree with each other and the X and Y directions. With such scanning it is possible to equip large-surface target substrates with a large number of semiconductor components without having to conduct alignment between each assembly step.

Scanning of the assembly positions on the target substrate is possible in this case by moving the target substrate forward successively in a grid step as soon as one row of the grid, which does not agree with the movement direction of the target substrate is equipped with semiconductor components.

To execute the method the device has two separate positioning units, each of which achieves a movement in one of the two directions deviating from each other for feed of the target substrate and for feed of the semiconductor components held by a transport device. Both positioning units are coupled to each other so that their movement directions meet in the assembly area. They have drives with which the precision required for reaching a defined assembly position can be achieved. Merely by these two positioning units, the assembly position for the target substrate and for the semiconductor components can be reached in the interaction area of the movement directions, as described above.

Since fine alignment of the semiconductor components relative to the target substrate can also be executed merely by alignment of the semiconductor components, in one variant of the method the target substrate is moved in the movement direction of the positioning unit of the target substrate to the assembly position and fixed there. The feed movement of the semiconductor components to the assembly position then occurs. As described above, this is possible, optionally after previous alignment of the semiconductor components with respect to angle and with respect to height, by their movement in the Y direction until the predefined distance has been covered or an adjustment mark is reached. The feed movement is significantly simplified and accelerated by this and prior alignment can be combined by further pretreatment steps in addition to the feed movement.

Such a movement is possible, for example, by means of a slide, which is moved forward on a rail system in one direction, in which systems that guarantee the required precision in direction and positioning are used both for the rail system and the drive. Different drives are known for movement of the slide and its positioning, which are generally driven digitally, but can also be driven in analog fashion.

Because of the flat extent of the target positions in semiconductor components to be assembled simultaneously, it can also be required to adjust the slope of the target substrate and semiconductor components relative to each other. Such a position of the target substrate and/or semiconductor components that has an angle to a plane that is defined by the two movement directions of the feed movements, which is defined as the X and Y direction and will be referred to below as the X-Y plane, will be understood to mean slope. Both the surface of the target substrate and the surfaces of the semiconductor components with which they are positioned on the target substrate can have such a slope.

The compensation for a slope can occur either by alignment to the X-Y plane or by adjustment of the surfaces to be joined with a remaining slope to the X-Y plane. This is possible by changing the slope of only one or both components, depending on which of the positioning units has a module that has a slope adjustment. In principle, both the positioning unit of the target substrate, for example, a slide here, and the positioning unit of the semiconductor components, for example, the transfer device here, have such a module.

As an alternative, the slope of one or more dispensers relative to the target substrate or relative the X-Y plane can also be leveled off so that each semiconductor component accepted by a level dispenser has the required slope. As described above, such uniform leveling can also occur for a number of target substrates, for example, in a magazine, in order to minimize the demands for alignment of the individual components in the continuous process.

For this purpose, in a further embodiment of the method, the height positions of the dispenser and target substrate are also adjusted relative to each other. A single height alignment therefore occurs, which can be maintained for several feed movements of one or more dispensers to one or several target substrates. In this way differences in thickness of target substrates are also compensated without having to intervene in a movement process of the feed movements once set or programmed.

Acceptance of the semiconductor components by the transfer device from the dispenser and positioning on the target substrate must also occur so that it can be used for an inline system both with respect to precision of assembly and with respect to time. In addition to mechanical mounts or suction, temporary gluing of the semiconductor components on a surface of the transfer device is also suitable. By the force with which the transfer device is pressed onto the semiconductor components present in the dispenser the adhesive effect can be deliberately adjusted. The necessary adhesive effect is determined by holding of the individual semiconductor components in the dispenser, on one hand, and must be releasable for assembly on the target substrate, on the other hand, without changing the alignment in the assembly position. For the latter the type of fastening of the semiconductor components on the part of substrate is decisive. This also often occurs by gluing so that the adhesives must be adjusted to each other.

By structuring the glue surfaces of the transfer device it is also possible to simultaneously accept several semiconductor components from the dispenser, whose position relative to each other already corresponds to their target position on the target substrate. For example, it is thus possible to accept for an array of semiconductor components in the dispenser every second or third of a row so that the spacing adjusted by this already corresponds to the spacing on the target substrate. Scanning of the dispenser is therefore again possible, while retaining the previously conducted alignment.

Based on the orders of magnitude explained above of the semiconductor components being assembled and the precision of positioning resulting from this and also to avoid adverse effects or even damage to the semiconductor components or target substrate, in another embodiment of the method, the transfer device is cleaned after assembly of a semiconductor component. In order to keep the cost for alignment between the target substrate and semiconductor components as low as possible even with this additional step, the cleaning device is arranged along or in an extension of the path that the transfer device covers for the feed movement. For cleaning the transfer device approaches the cleaning device in the Y direction and then moves, while retaining the direction, optionally with reversal of the direction, toward the dispenser and can accept the next semiconductor components. Cleaning itself can occur by different methods, depending on the anticipated soiling. For example, adhesive cleaning pads are known with which loose dirt particles or fragments can be removed or a fluid stream directed onto the transfer device or also wet chemical cleaning methods.

In comparable fashion, other processing stations both for the semiconductor components and for the target substrates can be arranged along the path of their feed movement in order to minimize process paths and alignment and thus cycle times.

It is also advantageous to remove semiconductor components recognized as defective within a pass from the target substrate again by the assembly device in order to equip these positions with a new semiconductor component. The necessary means are available with the positioning units and transfer device in the assembly device in order to approach the position of the defective semiconductor component, accept it and remove it. The replacement of defective components referred to as reworking is used to improve the yield and can be integrated here in an inline system.

Production and processing of semiconductor components occurs under clean room conditions in order to minimize particle contamination. For this reason, the described device has an enclosing housing so that assembly of the semiconductor components can occur under defined environmental conditions. In addition to the conditions of clean room classes, deliberate conditions with respect to pressure and temperature or with respect to light conditions can also be produced, depending on the requirements of the semiconductor components, the target substrate or the adjacent cells of an inline system in which the device is integrated.

### BRIEF DESCRIPTION OF THE DRAWING FIGURES

The invention will be further explained below by means of a practical example. In the corresponding drawing,

FIG. 1 shows a schematic view of an arrangement of target substrates and dispensers with semiconductor components with the feed movements to be executed;

FIG. 2 shows a top view of the parts of the device, which serve for the feed movement of the target substrate and handling of the dispenser up to the initial position for the feed movement of semiconductor components;

FIG. 3 shows a side view of the assembly device and

FIG. 4 shows a perspective view of a cluster with dispenser magazines and cleaning cassettes and a positioning unit of the semiconductor components with a transfer device.

### DETAILED DESCRIPTION

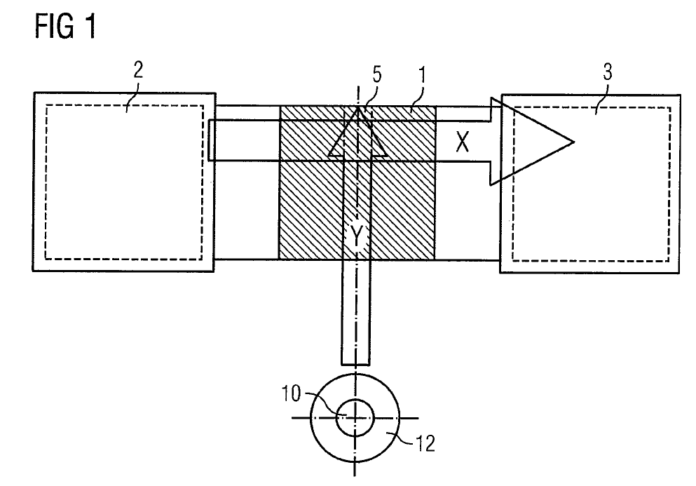

FIG. 1 shows a target substrate 1, which is moved by means of a first positioning unit in the X direction (not shown) and then held in at least one position in the assembly area 5. Semiconductor components (not further shown) are mounted on the target substrate 1 in this position and then movement in the X direction is continued. The starting point of the movement is a mount for empty target substrates 2 and the end point is a receptacle for the completely mounted target substrates 3. It goes without saying that the starting and end points of the movement of target substrate 1 can be reversed so that the X direction can be opposite the depicted direction. This X direction coincides with the passage direction of the system during integration of the assembly device in an inline system (not shown).

A dispenser receptacle 12, on which a dispenser 10 lies, is arranged to the side of the first positioning unit for movement of the target substrate 1 and with a spacing to it. The dispenser 10 is a wafer in the practical example, which includes a number of semiconductor components held appropriately in the wafer composite, for example, by bridge-like connections with each other or through an adhesive film on the back of the wafer. The semiconductor components accommodated by a transfer device (not shown) and released by dispenser 10 are moved in the Y direction, which lies in the practical example at a right angle to the X direction, into assembly area 5, positioned there above their target positions in which assembly occurs on the target substrate 1 and then lowered onto target substrate 1 and glued onto it.

Since the feed movements of the target substrate 1 and the semiconductor components can only occur in the X and Y directions, the assembly area 5, on the one hand, is determined by the width of the target substrate 1 across the X direction and, on the other hand, by the width of the dispenser 10 across the Y direction, or, if the transfer device has a smaller width than the dispenser 10, by its width across the Y direction. The assembly area 5 is therefore obtained from the intersection surface of these two areas and is a strip of the target substrate 1 with its width, which is bounded in the X direction by the front and rear closure of the dispenser 10 (shown with a dashed line) or optionally the transfer device. In this assembly area 5 it is possible, with a feed movement of the target substrate 1 and a feed movement of the semiconductor components, to mount semiconductor components onto the target substrate 1. In a subsequent step of the depicted target substrate 1, which is to be considered as the next feed movement, the assembly area 5 shifts onto the target substrate 1 by precisely this step.

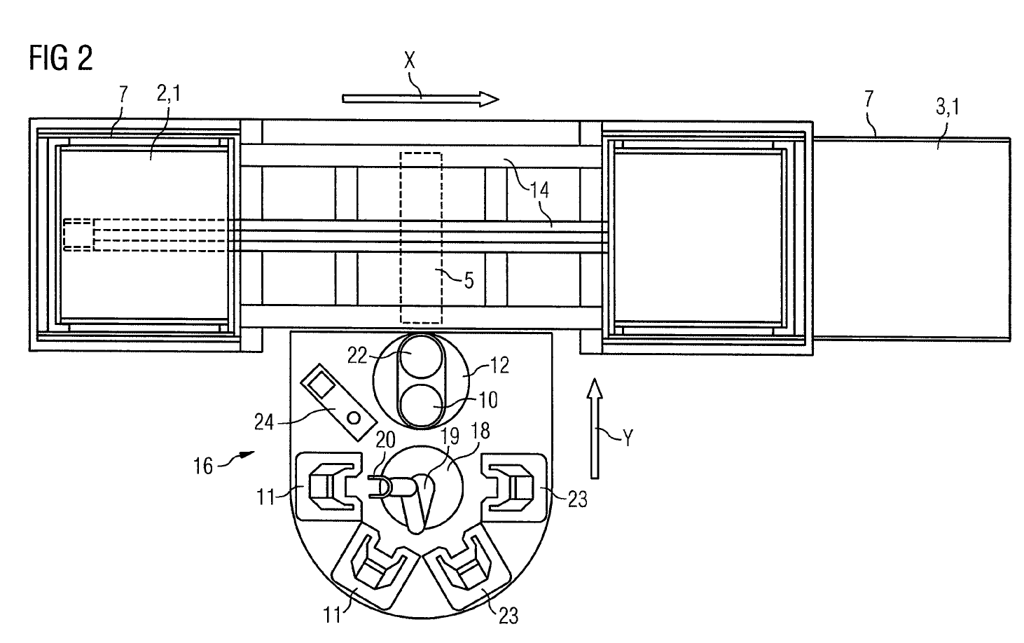

The two directions X and Y that determine the movement system are again shown in FIG. 2, which are accomplished with the first positioning unit 9 and a second positioning unit (not shown). The X direction extends from a starting point, here a magazine with empty target substrates 2, to an end point, here a magazine 7 with assembled target substrates 3. In both magazines 7 the target substrates 2, 3 are arranged precisely one above the other with an equivalent height spacing relative to each other. The magazine 7 of the assembled target substrates 3 is removed in the depiction of the device, for example, in order to replace it with a new empty one. With such magazines the storage and transport of several target substrates are also possible outside the assembly device under the required environmental conditions.

Movement of the target substrates 1 occurs by means of a slide 13 (not shown), which is moved fully or at least partially into magazine 7 to receive or deposit a target substrate 1. The slide is moved and positioned on a rail system 14 by means of an appropriate motor drive (not shown).

Each magazine 7 includes a coupling device (not shown) with which the magazine 7 is fastened on the rail system 14 in a defined geometric position relative to the slide 13 and can then be aligned. To remove a next empty target substrate 2, it is conveyed within the magazine 7 by an appropriate feed mechanism into the height in which the slide 11 can travel without changing its height position beneath the empty target substrate 2 and remove it from the magazine 7.

A cluster 16 of devices and dispenser magazines 11 for storage, handling and alignment of a number of dispensers 10 is arranged to the side of the movement path of the target substrates 1. A handling robot 18 is arranged centrally in this cluster 16, since the sensitivity of the semiconductor components with respect to breakage and any type of contamination from any contact with the human hand is prohibited. The handling robot 18 transports the dispenser 10 from one cluster station to another or in or out of a dispenser magazine 11.

Such a handling robot 18 generally consists of a robot arm 19, which is linked to a robot drive (not shown) and can be moved in a vertical degree of freedom (perpendicular to the plane of the drawing, subsequently referred to as the Z direction) and two horizontal degrees of freedom (X, Y) and pivotable around a vertical axis of rotation. On the free front side of the robot arm 19 a dispenser mount 20 is arranged, which can grasp a dispenser 10 and move it in or out of the stations or a dispenser magazine 11 in that the robot arm 19 positions through the robot drive its dispenser mount 20 directly beneath the bottom or back of a dispenser and brings it in contact and can be transported from one position to another.

The cluster 16, in addition to the handling robot 18 and a dispenser magazine 11 for full and empty dispensers 10, includes a dispenser receptacle 12, a cleaning device 22, here cleaning substrates 22, cleaning cassettes 23 to accommodate used and unused cleaning substrates 22 as well as a preadjuster 24. The dispenser receptacle 12 is configured so that a dispenser 10 and a cleaning substrate 22 can be arranged one behind the other in the Y direction. In the practical example the cleaning substrate 22 has the same size and shape as the dispenser 10 in order to completely clean the transfer device with reliability by simple mounting of a transfer device (not shown) on the cleaning substrate 22. If complete cleaning of the transfer device can be guaranteed in another way or cleaning occurs by another method, the cleaning substrate 22 can have a different shape or be replaced by another device, if this requires no movement component of the transfer device in the X direction. A separate movement of the cleaning device, on the other hand, does not interfere with the course of movement of the transfer device and therefore the semiconductor components.

By means of the preadjuster 24, also referred to as prealigner, a dispenser 10 can be precisely aligned in the X and Y direction and also at an angle on a fixed reference system of the assembly device. Retaining this prealignment, the dispenser 10 is placed on the dispenser receptacle 12. From there the transfer device accepts the semiconductor components with a defined prealignment. Since the other components of the assembly device are also defined on this geometric reference system and the target substrates 1 are furthermore referred to this reference system by a magazine 7 and its coupling device or can be determined by position sensing, a precise assignment of positions of the semiconductor components on the transfer device and the target positions on the target substrate 1 can occur. With knowledge of the positions, a final adjustment can also occur as needed by means of the transfer device or, if slide 13 permits, also by means of the slide.

By means of the handling robot 18 the dispensers 10 are moved between the individual dispenser magazines 11 and the cleaning cassettes 23, the dispenser receptacle 12 and the prealigner 24.

Because of the size and position of the target substrates 1 on the rail system 14 and the size and position of the dispensers 10 on the dispenser receptacle 12 the intersection surface of the assembly area 5 is again obtained.

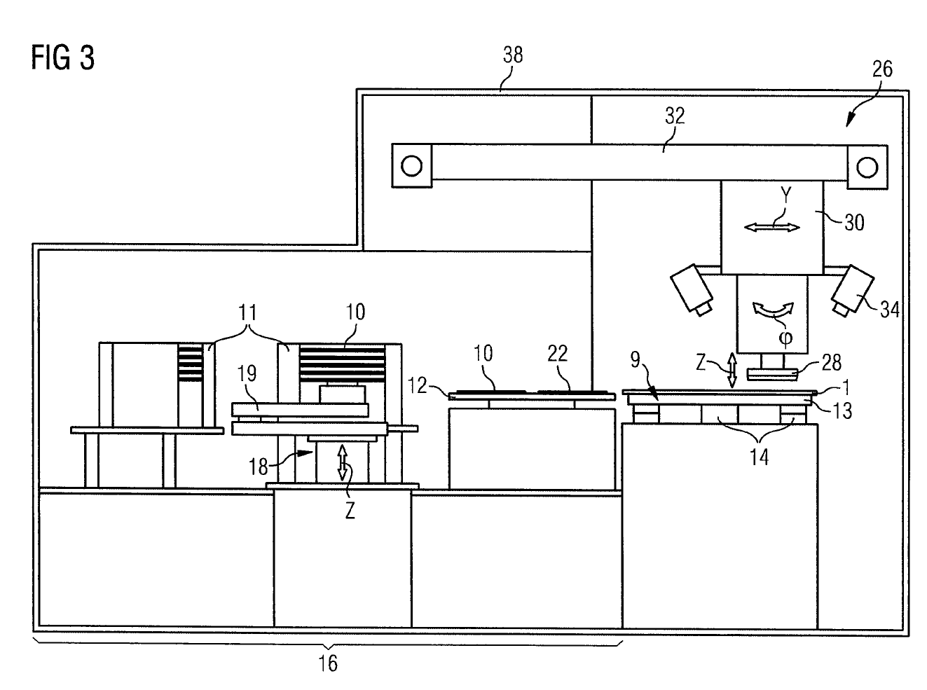

In the side view of the assembly device in FIG. 3 in addition to the components of the assembly device described above, the second positioning unit 26 is shown with a transfer device 28, in the practical example a punch. The second positioning unit 26 includes a head 30, which is mounted on a support 32 and moves along this support 32 in the Y direction with a motor drive (not shown) and can be stopped in predefined positions. A support 32 in conjunction with head 30 permits movement of the transfer device 28 arranged on the lower end of the head 30 from each location of the dispenser receptacle 12 to each location of the assembly area 5, but only in the Y direction.

For angular alignment of the transfer device 28 at least the lower part of the head 30 can be rotated around an axis of rotation lying in the Z direction (referred to as φ alignment). To accommodate the semiconductor components from the dispenser receptacle 12 and for placement and mounting of the semiconductor components on target substrate 1, as result of the aforementioned contacting movement, at least part of the second positioning device 26 or the transfer device 28 must be moved in the Z direction. In the practical example according to FIG. 3 the transfer device 28 can be moved in the Z direction.

The transfer device 28 and therefore also each process step conducted with the transfer device 28 is to be observed by one or, as in the practical example, also for three-dimensional observation, by several cameras 34 and evaluated in an image evaluation (not shown). In addition, observation of the prealigner 24 can also occur by additional cameras (not shown).

The entire assembly device is enclosed by a housing 38. For the other components of the assembly device depicted in FIG. 3, especially cluster 16, the explanations for FIG. 2 are referred to, in which the same components were designated with the same reference numbers.

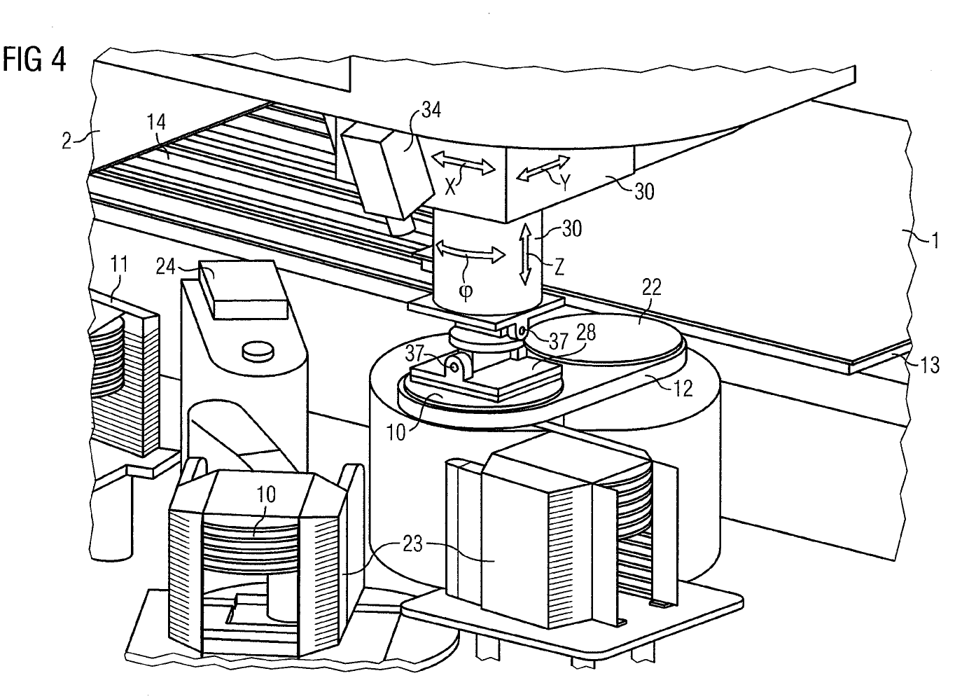

FIG. 4 shows an embodiment of the head 30 of the second position device 26 and the transfer device 28. The head 30 in this variant is to be moved over limited distances in the X direction in order to permit fine alignment even in this direction. Movement in the X direction can also be necessary when the receiving positions of the semiconductor components are to be scanned in succession in the dispenser. In this case the head 30 is moved by at least one grid dimension in the X direction in order to remove semiconductor components from a next row lying in the X direction. According to the invention movement of the head occurs in the X direction, however, not for actual feed of the semiconductor components but for the movements required beforehand.

In addition, the head 30 in FIG. 4 is also to be moved in the Y direction and specifically both for fine alignment and for execution of the feed movement, and is rotatable around an angle φ. The contacting movement in the Z direction is executed in the practical example depicted here by means of a lower part of the head 30.

Moreover, the transfer device is connected via a sloping module 36 for adjustment of the slope of the transfer device 28 and therefore the semiconductor component relative to the reference system of the assembly device and therefore relative to the target substrate 1 to the head 30. The slope is adjustable via two axes of rotation 37, which are arranged at right angles to each other and between the head and transport device 28 so that the transfer device can be tilted by two different solid angles α and β. For this purpose the one axis of rotation runs in the X direction and the other in the Y direction. As an alternative or in addition the target substrate 1 can be tiltable by means of the slide 13 in at least one of the solid angles α and β (not shown).

Here again, concerning the other components of the assembly device depicted in FIG. 4, the explanations for FIGS. 2 and 3 are referred to, in which the same components are designated with the same reference numbers.

For assembly of at least two semiconductor components on a target substrate 1, an empty target substrate 2 is initially moved by means of the first positioning unit 9, i.e., by means of the motor driven slide 13 described above and the rail system, in the X direction up to a position in which the target positions for the first semiconductor components to be mounted lie in the assembly area 5.

At the same time or subsequently, by means of the handling robot 18 a dispenser 10 is removed from a dispenser magazine 11 and positioned on the prealigner 24. The first alignment of the dispenser 10 occurs on the prealigner so that the position of the first semiconductor component to be removed from the dispenser 10 agrees largely with the X position of its target positions with consideration of the transport path to the dispenser receptacle 12. If a feed of the second positioning device 26 in the Y direction is already programmed, the Y positions can also already be largely adjusted to the target positions by means of the prealigner 24.

The handling robot 18 then transports the prealigned dispensers 10, while retaining the prealignment to the dispenser receptacle 12. The transfer device 28 is moved by means of the second positioning unit 26 over the dispenser, and lowered in the Z direction onto the dispenser. The transfer device has on its lower flat surface glue points which are arranged on a row lying in the Y direction and whose spacing relative to each other corresponds to the spacing of each second semiconductor component on dispenser 10. By a pressure force adjusted to the adhesive, the adhesive joined between the transfer device 28 and the semiconductor components is produced and the transport device is raised in the Z direction so that the semiconductor components are broken out from the composite. If required, fine adjustment in the X, Y, Z, φ, α or β directions now occurs.

The feed movement in the Y direction now occurs until the semiconductor components are positioned precisely above the target positions on target substrate 1. The end of the feed movement can be established by a position measurement of the transfer device 28, by a determination of the distance covered with the drive or by reaching a reference mark. The contacting movement in the Z direction is then executed and the semiconductor components are fastened by a defined pressure with glue points onto the target substrate. Through a defined acceleration during raising of the transport device 28 from the target substrate 1, optionally combined with a tilting movement of the transfer device in one of the solid angles α or β, the glue joint between the transfer device 28 and semiconductor components is released, whereas the glue joint between the target substrate 1 and the semiconductor components persists. For this transfer process a precise adjustment of the glue sites and adhesives between the transfer device 28, semiconductor components and target substrate 1 is essential.

The feed movement will then run backwards until the transfer device 28 is situated above the cleaning substrate 22, the transfer device 28 is lowered onto the tacky cleaning substrate 22 in the Z direction so that contaminants, for example, fragments from breakout of semiconductor components from the wafer composite are removed and the next semiconductor components can then be removed from the dispenser 10 arranged on the dispenser receptacle 12. For this purpose the head is moved further in the X and/or Y direction until free glue points of the transfer device 28 are positioned precisely above the receiving positions of the dispenser 10. The described procedure to receive the semiconductor components, fine adjustment, feed movement, assembly and cleaning are now to be continuously repeated until the target substrate 1 is fully equipped.

At the latest, at the point when all target positions are occupied within the assembly area 5, the target substrate 1 is moved further in the X direction by the width of the assembly area 5 or part of it. As an alternative, the movements of the head 30 in the X direction can also be combined with stepwise movements of the target substrate 1 in the X direction in order to optimize the costs for feed and alignment.

If, in the meantime, all semiconductor components of a dispenser 1 [sic] have been assembled, during assembly of the last semiconductor components the next dispenser 1 [sic] can already be prealigned, the empty dispenser 1 [sic] positioned in a dispenser magazine 11 and the new prealigned dispenser 10 positioned on the dispenser receptacle 12 in order to permit continuous assembly.

In addition to these processes, some of the other described process steps can be executed simultaneously, if they can be executed independently of each other. In addition to prealignment, this concerns removal or positioning of the target substrates 1, 2, 3 and/or dispensers 10 in their magazines 7, 11 or also replacement of clean substrates 22, which is also possible by means of handling robot 18 in the practical example.

1. Method for assembly of several semiconductor components onto a target substrate, in which at least two semiconductor components are removed from a dispenser by a transfer device and mounted simultaneously in predefined target positions on the target substrate, wherein feed of the target substrate into an assembly area in which the semiconductor components are mounted on the target substrate, occurs in a first X direction, and feed of the transfer device with the semiconductor components into the assembly area occurs in a second Y direction, and both directions deviate from each other and the assembly area represents surroundings of an intersection point of the X and Y directions and removal of a processed target substrate from the assembly area continues its feed movement.

2. Method according to claim 1, wherein the semiconductor components are mounted with a spacing to each other.

3. Method according to claim 1, wherein the X and Y directions lie substantially perpendicular to each other.

4. Method according to claim 1, wherein, for feed, a target substrate is moved by a first positioning unit into the assembly area, positioned and fixed in an assembly position, and feed of the semiconductor components held by the transfer device then occurs by a second positioning unit to the assembly position.

5. Method according to claim 4, wherein, for assembly of a number of semiconductor components, the first positioning unit travels past several assembly areas in steps with a step width according to spacing of two semiconductor components in the X direction.

6. Method according to claim 1, wherein slope of the target substrate is adjusted relative to slope of contact surfaces of the semiconductor components with which the semiconductor components lie on the target substrate.

7. Method according to claim 1, wherein slope of the semiconductor components is adjusted relative to the target substrate.

8. Method according to claim 1, wherein slope of the dispenser is adjusted relative to a slope of the target substrate.

9. Method according to claim 1, wherein height position of the dispenser is adjusted relative to a height position of the target substrate by a dispenser receptacle.

10. Method according to claim 1, wherein the transfer device comprises a punch, and a surface of the punch has sections that at least temporarily adhere.

11. Method according to claim 1, wherein the transfer device after assembly of the semiconductor components is cleaned by a cleaning device arranged along or in an extension of a path in the Y direction for feed of the semiconductor components, and a second positioning unit reaches in succession in the Y direction positions for assembly of the semiconductor components, for cleaning of the transfer device and for receiving new semiconductor components.

12. Method according to claim 1, wherein a defective semiconductor component is disassembled from the target substrate by a removal device.

13. Method according to claim 1, wherein assembly occurs in a closed housing in which defined environmental conditions are established and maintained.

14. Method according to claim 1, wherein a number of target substrates are held in a transportable magazine and the target substrate to be equipped with semiconductor components is removed from the magazine by a slide.

15. Device for assembly of several semiconductor components onto a target substrate, having positioning units for positioning of the semiconductor components relative to the target substrate and a transfer device to remove at least two semiconductor components from a dispenser and simultaneous assembly of the components onto the target substrate in predefined target positions, wherein a first positioning unit for movement of the substrate is arranged along a path, and including a second positioning unit for feed of the transfer device with the semiconductor components into an assembly area in which the semiconductor components are mounted on the target substrate, and the first positioning unit is adapted to be moved in a first X direction, and the second positioning unit is adapted to be moved in a second Y direction, both directions deviating from each other and the assembly area representing an area in which feed movement of the semiconductor components occurs on the path of the target substrate.

16. Device according to claim 15, wherein the X and Y directions are substantially perpendicular to each other.

17. Device according to claim 15, wherein the first positioning unit includes a slide for movement of the target substrate in the X direction, and the slide is adapted to be fixed in an assembly position in the assembly area.

18. Device according to claim 15, wherein at least one of the positioning units includes a module for fine alignment of the semiconductor components or the target substrate relative to each other in the X and Y directions and in an angle lying in one of planes defined by the X and Y directions.

19. Device according to claim 15, wherein at least one positioning unit includes a module for sloping of a reference surface of the target substrate or the semiconductor component relative to a plane defined by the X and Y directions around a predefined angle.

20. Device according to claim 15, wherein the transfer device includes a punch having a punch surface with at least temporarily adhering sections to accommodate the semiconductor components.

21. Device according to claim 17, further including a transportable magazine in which a number of target substrates are kept for removal by the slide.

22. Device according to claim 15, further comprising a cleaning device for cleaning the transfer device, wherein the dispenser and the cleaning device are arranged along or in extension of the path in the Y direction for feed of the semiconductor components.

23. Device according to claim 15, wherein slope of the semiconductor components relative to a slope of the target substrate is adjustable by the transfer device.

24. Device according to claim 15, wherein a dispenser receptacle is arranged, for positioning of the dispenser on a line defined by the Y direction in a predefined position in the X and Y directions, as well as a predefined angle, which lies in a plane defined by the X and Y directions.

25. Device according to claim 24, wherein slope of the dispenser relative to a slope of the target substrate is adjustable by the dispenser receptacle.

26. Device according to claim 24, wherein height position of the dispenser is adjustable relative to a height position of the target substrate by the dispenser receptacle.

27. Device according to claim 15, further including a removal device to remove at least one semiconductor component from the target substrate.

28. Device according to claim 15, further including an enclosing housing in which defined environmental conditions are set and maintained.
